(19) United States
(12) Patent Application Publication
(10) Pub. No.: US 2015/0116902 A1
(43) Pub. Date: Apr. 30, 2015

(54) MULTILAYER CERAMIC ELECTRONIC COMPONENT AND MOTHER CERAMIC MULTILAYER BODY

(71) Applicant: Murata Manufacturing Co., Ltd., Nagaokakyo-shi (JP)

(72) Inventor: Satoki SAKAI, Nagaokakyo-shi (JP)

(21) Appl. No.: 14/522,627

(22) Filed: Oct. 24, 2014

(30) Foreign Application Priority Data
Oct. 30, 2013 (JP) 2013-225322
Jul. 28, 2014 (JP) 2014-152855

(51) Int. Cl. H01G 4/30; H01G 4/38; H01G 4/248; H01G 4/012; H01G 4/12

(52) U.S. Cl. CPC H01G 4/30; H01G 4/012; H01G 4/12; H01G 4/248; H01G 4/38
USPC 361/301.4

(57) ABSTRACT

A multilayer ceramic electronic component includes a ceramic body, first and second outer electrodes, and a plurality of first and second inner electrodes opposing each other across ceramic layers in a lamination direction of the ceramic body. At least two inner electrodes among the plurality of first and second inner electrodes include bent portions on lead-out regions as portions on which the plurality of first inner electrodes and the plurality of second inner electrodes do not oppose each other across the ceramic layers in the lamination direction, and vertexes of the bent portions of the inner electrodes adjacent in the lamination direction are at different positions in a lead-out direction.

### BACKGROUND OF THE INVENTION

1. Field of the Invention

The present invention relates to a multilayer ceramic electronic component and a mother ceramic multilayer body for manufacturing a multilayer ceramic electronic component.

2. Description of the Related Art

In recent years, in a multilayer ceramic electronic component such as a multilayer ceramic capacitor, size reduction and an increase in an electrostatic capacitance are desired. Therefore, the number of inner electrodes that are laminated is increased. As the number of inner electrodes that are laminated is increased, the inner electrodes are crowded in an opposing region where the inner electrodes that are connected to different potentials oppose each other in the lamination direction. Thus, the density of the inner electrodes becomes higher in the opposing region.

In a lead-out region where the inner electrodes do not oppose each other, the inner electrodes that are led out are any one of the inner electrodes that are connected to the different potentials. Therefore, the density of the inner electrodes in the lead-out region is lower than that in the opposing region. Thus, as the number of inner electrodes that are laminated is increased, the difference in the density of the inner electrodes between the opposing region and the lead-out region is larger.

When the difference in the density of the inner electrodes between the opposing region and the lead-out region is larger, it is difficult for a pressing pressure to act on the lead-out region on which the density of the inner electrodes is small. This results in delamination being easily generated between the inner electrodes and the ceramic layers. This problem is significant when individual ceramic multilayer bodies are manufactured by cutting a raw mother ceramic multilayer body.

For coping with the above-mentioned delamination problem, for example, Japanese Unexamined Patent Application Publication No. 2-161713 discloses a method in which the upper surface and the lower surface of the ceramic multilayer body are covered with rubber and isostatic pressing is carried out thereto.

However, even the isostatic pressing as described in Japanese Unexamined Patent Application Publication No. 2-161713 does not sufficiently suppress the delamination that occurs when the raw mother ceramic multilayer body is cut in the ceramic electronic component in which the number of inner electrodes that are laminated is increased.

### SUMMARY OF THE INVENTION

Accordingly, preferred embodiments of the present invention provide a multilayer ceramic electronic component and a mother ceramic multilayer body configured to make it difficult and unlikely that delamination between an inner electrode and a ceramic layer can occur.

According to a preferred embodiment of the present invention, a multilayer ceramic electronic component includes a ceramic body including a plurality of ceramic layers and includes first and second main surfaces and first and second end surfaces, first and second outer electrodes that are provided on the first and second end surfaces of the ceramic body, respectively, and a plurality of first and second inner electrodes that are led out onto the first and second end surfaces of the ceramic body, respectively, and oppose each other across the ceramic layers in a lamination direction of the ceramic body, a region in which the plurality of first inner electrodes and the plurality of second inner electrodes oppose each other corresponds to an opposing region, and portions which are located between the opposing region and the first end surface and between the opposing region and the second end surface and on which the plurality of first inner electrodes and the plurality of second inner electrodes do not oppose each other correspond to lead-out regions, at least two inner electrodes which are located next to each other via the ceramic layer among the plurality of first and second inner electrodes include bent portions in the lead-out regions, and a vertex of a bent portion of the inner electrode and a vertex of a bent portion of the inner electrode adjacent to the inner electrode in the lamination direction are provided at different positions in the lead-out direction in one lead-out region.

According to a specific aspect of the multilayer ceramic electronic component in a preferred embodiment of the present invention, it is preferable that at least one bent portion be provided on each of at least three inner electrodes aligned to be adjacent in the lamination direction among the plurality of first and second inner electrodes.

According to another specific aspect of the multilayer ceramic electronic component in a preferred embodiment of the present invention, it is preferable that a position of a vertex of a bent portion which is closest to the opposing region in the lead-out direction of the first and second inner electrodes in the at least one bent portion be deviated to a side of the opposing region in the lead-out direction toward a side of the second main surface of the ceramic body from a side of the first main surface of the ceramic body in the lamination direction.

According to another preferred embodiment of the present invention, a mother ceramic multilayer body in a raw state includes a plurality of ceramic green sheets, is an aggregate of a plurality of multilayer ceramic electronic component constituent units including first and second end surfaces, and includes first and second main surfaces, the multilayer ceramic electronic component constituent units include the plurality of ceramic green sheets, and a plurality of first and second inner electrodes that are led out onto the first and second end surfaces of the multilayer ceramic electronic component constituent units, respectively, and oppose each other across the ceramic green sheets in a lamination direction of the plurality of ceramic green sheets, regions in which the plurality of first inner electrodes and the plurality of second inner electrodes oppose each other correspond to opposing regions, and portions which are located between the opposing regions and the first end surfaces and between the opposing regions and the second end surfaces and on which the plurality of first inner electrodes and the plurality of second inner electrodes do not oppose each other correspond to lead-out regions, in a mother lead-out region configured by coupling the lead-out regions of first and second multilayer ceramic electronic component constituent units as the multilayer ceramic electronic component constituent units adjacent to each other, at least two adjacent inner electrodes among the plurality of first and second inner electrodes include bent portions, and bent portions of which vertex of the bent portion of the inner electrode and vertex of the bent portion of the inner electrode adjacent to the inner electrode in the lamination direction are provided at different positions in the lead-out direction are included in one lead-out region.

According to a specific aspect of the mother ceramic multilayer body in a preferred embodiment of the present invention, it is preferable that the plurality of first and second inner electrodes include an inner electrode on which at least three bent portions are provided per inner electrode in one mother lead-out region.

According to another specific aspect of the mother ceramic multilayer body in a preferred embodiment of the present invention, it is preferable that among the at least three bent portions, a distance between a vertex of a bent portion which is closest to the opposing region of the first multilayer ceramic electronic component constituent unit in the lead-out direction of the first and second inner electrodes and a vertex of a bent portion which is closest to the opposing region of the second multilayer ceramic electronic component constituent unit in the lead-out direction become larger toward a side of the second main surface of the mother ceramic multilayer body from a side of the first main surface of the mother ceramic multilayer body in the lamination direction.

According to still another specific aspect of the mother ceramic multilayer body in a preferred embodiment of the present invention, it is preferable that one mother lead-out region include an inner electrode including three bent portions per inner electrode.

According to still another specific aspect of the mother ceramic multilayer body in a preferred embodiment of the present invention, it is preferable that one mother lead-out region include an inner electrode including four bent portions per inner electrode.

According to still another specific aspect of the mother ceramic multilayer body in a preferred embodiment of the present invention, it is preferable that among the four bent portions, a distance between vertexes of two bent portions other than the bent portion which is closest to the opposing region of the first multilayer ceramic electronic component constituent unit and the bent portion which is closest to the opposing region of the second multilayer ceramic electronic component constituent unit become larger toward a side of the second main surface of the mother ceramic multilayer body from a side of the first main surface of the mother ceramic multilayer body in the lamination direction.

Various preferred embodiments of the present invention provide multilayer ceramic electronic components and mother ceramic multilayer bodies that are resistant to and prevent delamination from occurring between an inner electrode and a ceramic layer.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a perspective view illustrating a multilayer ceramic capacitor according to a preferred embodiment of the present invention, and FIG. 1B is a cross-sectional view cut along a line A-A in FIG. 1A.

FIG. 2A is a cross-sectional view illustrating a mother ceramic multilayer body according to a preferred embodiment of the present invention, and FIGS. 2B and 2C are enlarged views illustrating a bent portion of an inner electrode shown in FIG. 2A.

FIG. 3 is a schematic plan view when an existing mother ceramic multilayer body is cut.

FIG. 4 is a schematic plan view when the mother ceramic multilayer body according to a preferred embodiment of the present invention is cut.

FIGS. 5A and 5B are cross-sectional views illustrating a method of manufacturing the multilayer ceramic capacitor according to a preferred embodiment of the present invention.

FIGS. 6A to 6C are cross-sectional views illustrating a method of manufacturing a multilayer ceramic capacitor according to a preferred embodiment of the present invention.

### DETAILED DESCRIPTION OF THE PREFERRED EMBODIMENTS

Hereinafter, various preferred embodiments of the present invention will be explained with reference to the drawings.

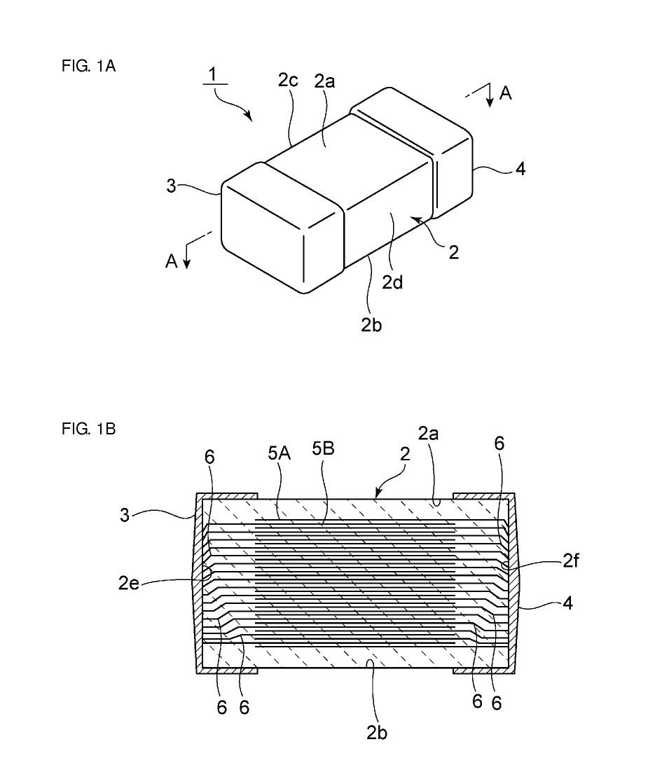

FIG. 1A is a perspective view illustrating a multilayer ceramic capacitor according to a preferred embodiment of the present invention and FIG. 1B is a cross-sectional view cut along a line A-A in FIG. 1A.

A multilayer ceramic capacitor 1 includes a ceramic body 2, first and second outer electrodes 3 and 4, and inner electrodes 5A and 5B. The ceramic body 2 includes a plurality of ceramic layers laminated on each other. The ceramic body 2 preferably has a rectangular or substantially rectangular parallelepiped shape including first and second main surfaces 2a and 2b, first and second side surfaces 2c and 2d, and first and second end surfaces 2e and 2f. The first and second main surfaces 2a and 2b extend along the lengthwise direction and the width direction. The first and second side surfaces 2c and 2d extend along the lengthwise direction and the thickness direction. The first and second end surfaces 2e and 2f extend along the width direction and the thickness direction.

The dimension of the multilayer ceramic capacitor is not particularly limited. For example, the multilayer ceramic capacitor of which length dimension, width dimension, and height dimension preferably are about 1.0 mm×about 0.5 mm×about 0.5 mm, about 0.6 mm×about 0.3 mm×about 0.3 mm, or about 0.4 mm×about 0.2 mm×about 0.2 mm can be used in a preferred embodiment of the present invention.

An appropriate material is used for the ceramic body 2. In the present preferred embodiment, dielectric ceramics of which main component is BaTiO3 or CaZr is preferably used therefor, for example.

The first and second outer electrodes 3 and 4 are provided on the outer surfaces of the ceramic body 2 and are provided on the first and second end surfaces 2e and 2f of the ceramic body 2, respectively. Although a material of the first and second outer electrodes 3 and 4 is not particularly limited, a metal such as Ag, Ni, Cu, Pd, or Au is preferably used, for example.

The plurality of first and second inner electrodes 5A and 5B are preferably led out onto the first or second end surface 2e or 2f of the ceramic body 2. The plurality of first inner electrodes 5A and the plurality of second inner electrodes 5B oppose each other across the ceramic layers in the lamination direction of the ceramic body 2. In the specification, a portion on which the plurality of first inner electrodes 5A and the plurality of second inner electrodes 5B oppose each other across the ceramic layers correspond to an opposing region. Portions which are located between the opposing region and the first end surface 2e and between the opposing region and the second end surface 2f and on which the plurality of first inner electrodes 5A and the plurality of second inner electrodes 5B do not oppose each other across the ceramic layers correspond to lead-out regions.

Although a material of the plurality of first and second inner electrodes 5A and 5B is not also particularly limited, a metal including a main component that is a base metal such as Ni or Cu is preferably used, for example.

In a preferred embodiment of the present invention, at least two inner electrodes among the plurality of first and second inner electrodes 5A and 5B include bent portions 6 in each of the lead-out regions. Further, in a preferred embodiment of the present invention, the bent portions 6 of the inner electrodes adjacent in the lamination direction are provided at different positions in the lead-out direction. The bent portions 6 are portions obtained by bending the inner electrodes and can be observed under a scanning electron microscope on a cross section parallel or substantially parallel with the first and second side surfaces 2c and 2d. In a preferred embodiment of the present invention, the cross section corresponds to a cross section cut along a line A-A in FIG. 1A. The bent portions 6 extend in the width direction. The bent portions 6 are portions on which the extension direction of the inner electrodes change abruptly. Alternatively, the bent portions 6 are portions on which the inner electrodes extending from one side are bent at an angle that is equal to or higher than about 5°, and preferably equal to or higher than about 10°, for example. This is because as an angle at which the inner electrode is bent becomes larger, a wedge effect, which will be described later, becomes larger. The angle at which each inner electrode is bent is an angle defined by two straight lines drawn along the extension direction of the inner electrode before and after the extension direction of the inner electrode changes abruptly. A point defining an inflection point on the portion on which the extension direction of the inner electrode changes abruptly is set to be a vertex. In other words, a point at which the angle is the steepest is set to be the vertex. The vertexes of the bent portions have the largest wedge effect.

In a preferred embodiment of the present invention, the bent portions 6 are provided on the inner electrodes as described above. Therefore, the wedge effect of the bent portions 6 enhances the adhesion property between the inner electrodes and the ceramic layers. Thus, delamination between the inner electrodes and the ceramic layers is significantly reduced or prevented with the wedge effect.

The plurality of first and second inner electrodes 5A and 5B preferably include the inner electrodes each of which is provided with at least one bent portion 6 per inner electrode. A position of a vertex of the bent portion 6 which is closest to the opposing region in the lead-out direction among the at least one bent portion 6 is preferably deviated to the opposing region side in the lead-out direction toward the second main surface 2b side of the ceramic body from the first main surface 2a side of the ceramic body in the lamination direction. In this case, wedges with the bending are arranged over a wide range so as to enhance the adhesion property between the inner electrodes and the ceramic layers over a wider range. Thus, in order to enhance the adhesion property between the inner electrodes and the ceramic layers over a wider range, lines connecting the vertexes of the bent portions 6 are preferably non-parallel with respect to the first or second end surface and lines connecting the vertexes of the bent portions 6 are preferably nonlinear. Further, if the deviation widths of the vertexes of the bent portions 6 exhibiting the wedge effect are reduced, the adhesion property between the inner electrodes and the ceramic layers is enhanced over a wider range. Based on this, the deviation widths of the vertexes of the bent portions 6 preferably are smaller than the thicknesses of the ceramic layers.

Other preferred embodiments of the present invention provide a raw mother ceramic multilayer body as an aggregate of the plurality of multilayer ceramic electronic component constituent units.

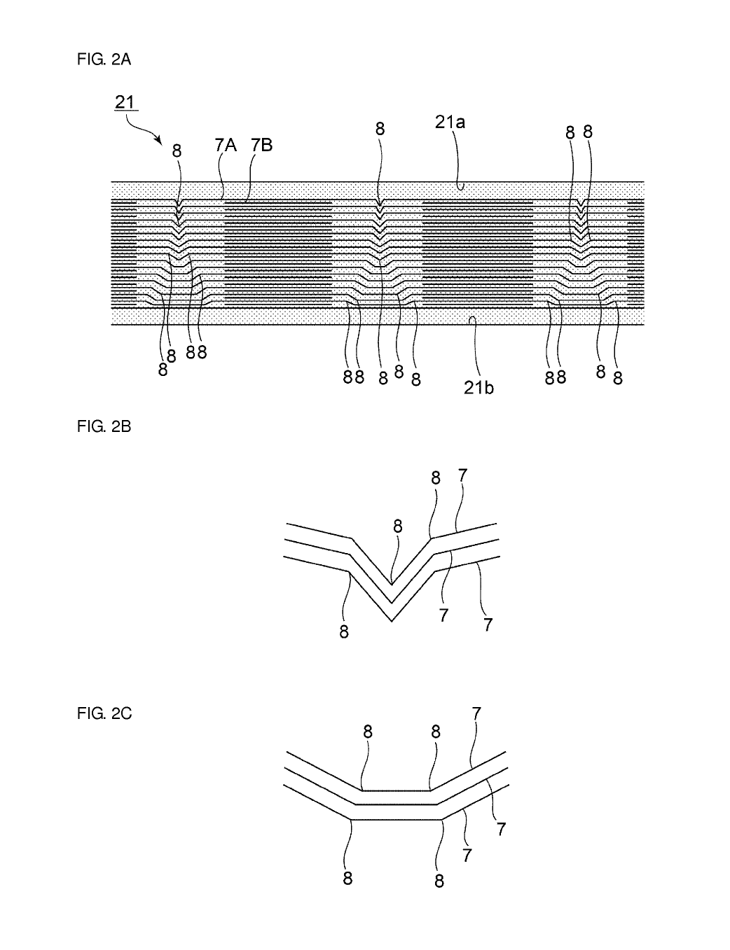

FIG. 2A is a cross-sectional view illustrating a mother ceramic multilayer body according to a preferred embodiment of the present invention. FIGS. 2B and 2C are enlarged views of the bent portions of the inner electrodes in FIG. 2A.

The mother ceramic multilayer body 21 includes first and second main surfaces 21a and 21b. The mother ceramic multilayer body 21 includes a plurality of ceramic green sheets laminated on each other. The mother ceramic multilayer body 21 is an aggregate of the multilayer ceramic electronic component constituent units including first and second end surfaces (not illustrated).

The multilayer ceramic electronic component constituent units include the plurality of ceramic green sheets and a plurality of first and second inner electrodes 7A and 7B. The plurality of first and second inner electrodes 7A and 7B are led out on the first or second end surfaces of the multilayer ceramic electronic component constituent units. The plurality of first inner electrodes 7A and the plurality of second inner electrodes 7B oppose each other across the ceramic green sheets in the lamination direction of the plurality of ceramic green sheets.

In the specification, portions on which the plurality of first inner electrodes 7A and the plurality of second inner electrodes 7B oppose each other across the ceramic green sheets correspond to opposing regions. Regions that are located between the opposing regions and the first end surfaces and between the opposing regions and the second end surfaces and on which the plurality of first inner electrodes 7A and the plurality of second inner electrodes 7B do not oppose each other across the ceramic green sheets correspond to lead-out regions. Further, pairs of adjacent multilayer ceramic electronic component constituent units are set to first and second multilayer ceramic electronic component constituent units and regions configured by coupling the lead-out regions of the first and second multilayer ceramic electronic component constituent units are set to mother lead-out regions.

In a preferred embodiment of the present invention, at least two inner electrodes among the plurality of first and second inner electrodes 7A and 7B include bent portions 8 on the respective mother lead-out regions. The bent portions 8 of the inner electrodes adjacent in the lamination direction preferably include the bent portions provided at different positions in the mother lead-out regions.

Also in the mother ceramic multilayer body according to a preferred embodiment of the present invention, the bent portions are preferably configured in the same manner as the multilayer ceramic component according to a preferred embodiment of the present invention as described above, thus enhancing the adhesion property between the inner electrodes and the ceramic layers with the wedge effect.

In a preferred embodiment of the present invention, the plurality of first and second inner electrodes 7A and 7B preferably include inner electrodes each of which is provided with at least three bent portions 8 in one mother lead-out region, for example. Preferably, each of the plurality of first and second inner electrodes 7A and 7B preferably includes three or four bent portions 8 in one mother lead-out region.

As illustrated in FIG. 2B, when the three bent portions 8 are present, the adhesion property between the inner electrodes 7 and the ceramic layers is enhanced over a wider range in the lamination direction. On the other hand, as illustrated in FIG. 2C, when the four bent portions 8 are present, the adhesion property between the inner electrodes 7 and the ceramic layers is enhanced over a much wider range in the lead-out direction. The bending pattern is not limited to those as illustrated in FIG. 2B and FIG. 2C and may be another pattern.

In a preferred embodiment of the present invention, as illustrated in FIG. 2A, a distance between the bent portion 8 which is closest to the opposing region of the first multilayer ceramic electronic component constituent unit in the lead-out direction and the bent portion 8 which is closest to the opposing region of the second multilayer ceramic electronic component constituent unit in the lead-out direction is larger toward the second main surface 21b of the mother ceramic multilayer body 21 from the first main surface 21a of the mother ceramic multilayer body 21 in the lamination direction.

Further, when the four bent portions 8 are present, a distance between the two bent portions 8 other than the bent portion 8 which is closest to the opposing region of the first multilayer ceramic electronic component constituent unit and the bent portion 8 which is closest to the opposing region of the second multilayer ceramic electronic component constituent unit is preferably larger toward the second main surface 21b of the mother ceramic multilayer body 21 from the first main surface 21a of the mother ceramic multilayer body 21 in the lamination direction. In this case, the distance between the two bent portions 8 as a region in which the difference in density is eliminated is ensured to be large, thus further widening the region in which the adhesion force is improved.

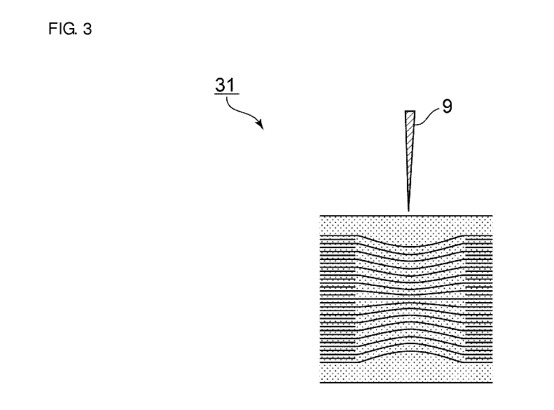

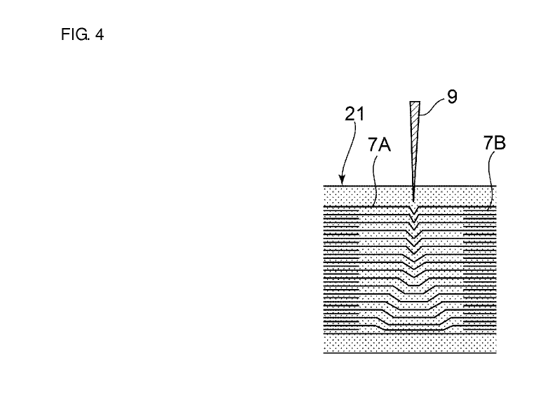

The mother ceramic multilayer body according to a preferred embodiment of the present invention is normally cut by cutting with a cutting blade 9 as illustrated in FIG. 3 and FIG. 4. Therefore, in an existing mother ceramic multilayer body 31 as illustrated in FIG. 3, stripping significantly has been experienced due to stress that is generated when cutting. In contrast, the raw mother ceramic multilayer body according to a preferred embodiment of the present invention includes various bent portions as described above. Therefore, the wedge effect with the bent portions significantly reduces or prevents the stripping due to the stress generated when cutting more effectively.

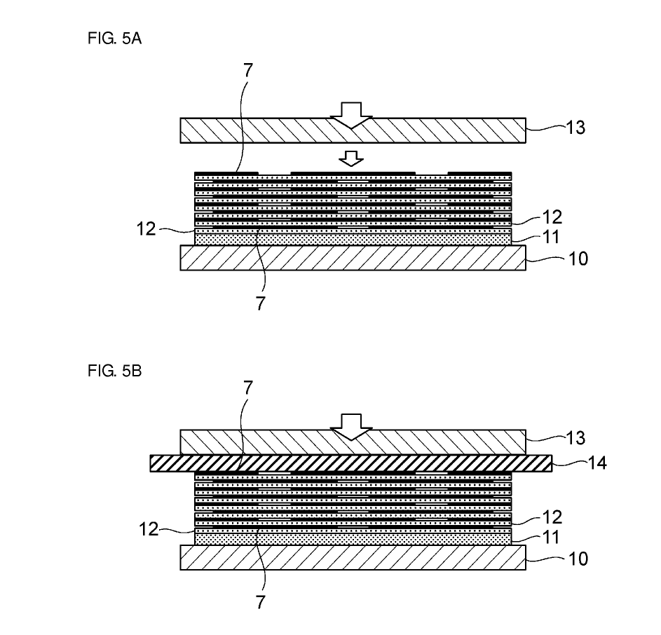

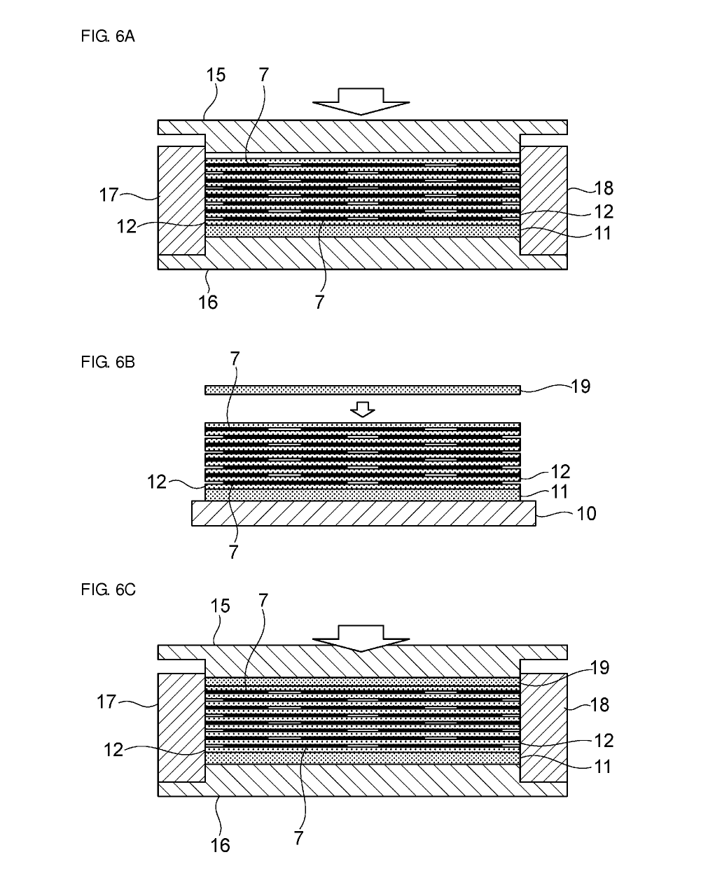

Next, a non-limiting example of a method of manufacturing a multilayer ceramic capacitor as an example of the multilayer ceramic electronic component according to a preferred embodiment of the present invention will be described with reference to FIGS. 5A and 5B and FIGS. 6A to 6C. In the manufacturing method, the opposing regions, the lead-out regions, and the mother lead-out regions indicate those as described in the above-mentioned mother ceramic multilayer body 21.

First, as illustrated in FIG. 5A, a mother first ceramic outer layer 11 is formed on a lamination base 10. The mother first ceramic outer layer 11 may be formed by placing a ceramic green sheet or may be formed by printing or coating of ceramic pastes. It should be noted that the process may be omitted.

Next, mother ceramic green sheets 12 on which the plurality of inner electrodes 7 are printed on the main surfaces are sequentially laminated on the mother first ceramic outer layer 11. In this case, the mother ceramic green sheets 12 are laminated in such a manner that the mother green sheet 12 is held by an adsorption head 13 one by one and pressure is applied to the mother ceramic green sheet 12 placed previously for pressure bonding. With the pressure bonding, the inner electrodes 7 or the raw ceramic layers are extruded to the mother lead-out regions from the opposing regions, so that the inner electrodes 7 deflect in the mother lead-out regions. In the first process, 1 to 100 mother ceramic green sheets 12 are laminated.

Next, as illustrated in FIG. 5B, the adsorption head 13 is separated from the mother ceramic green sheets 12 once and a molded sheet 14 is placed between the laminated mother ceramic green sheets 12 and the adsorption head 13. The molded sheet 14 is not particularly limited but preferably has rubber elasticity. More preferably, the molded sheet 14 is a rubber sheet. The mother ceramic green sheet 12 that is laminated subsequently may preferably be used as the molded sheet.

Thereafter, the adsorption head 13 applies a pressing force from the upper side of the molded sheet 14 in the lamination direction. In this case, pressure is applied from the upper side of the molded sheet 14, so that a strong pressure is applied to the mother lead-out regions in comparison with that in the pressure bonding in the first process. This generates bending of the inner electrodes 7 on the portions deflected in the first process, particularly. In the case, bending is generated at the centers of the mother lead-out regions in some cases.

In a third process, the first process and the second process are repeatedly performed. The pressure is repeatedly applied to the inner electrode that is laminated at an earlier stage. Therefore, the difference in the bending manner is generated among the inner electrodes 7 adjacent in the lamination direction. Further, the positions of the bending of the inner electrodes are deviated in the lead-out direction as the lamination advances. The pressing in the second process may be performed every time one mother ceramic green sheet 12 is laminated in the first process. Also in any cases, the bent portions of the inner electrodes 7 are deviated in the lead-out direction as the lamination of the mother ceramic green sheet 12 advances.

Then, a mother ceramic inner-side portion outer layer that is thinner than the mother ceramic green sheet 12 and on which no inner electrode 7 is printed is formed on the laminated mother ceramic green sheets 12. The mother ceramic inner-side portion outer layer is not illustrated in the drawings. The mother ceramic inner-side portion outer layer that is thinner than the mother first ceramic outer layer 11 is preferably used. The mother ceramic inner-side portion outer layer can protect the inner electrode 7 that is exposed to the outermost surface from contact with the outside.

The mother ceramic inner-side portion outer layer may be formed by placing the ceramic green sheet as in one of the preferred embodiments of the present invention or may be formed by printing or coating of ceramic pastes. Further, the mother ceramic inner-side portion outer layer may include an internal conductive layer that does not substantially contribute to the electrostatic capacity of the obtained capacitor. For example, the internal conductive layer can be overlapped at the same position as the inner electrodes 7.

The plurality of mother ceramic green sheets 12 and the mother ceramic inner-side portion outer layer are preferably formed by the same composition of an inorganic material for the following reason. That is, when the compositions of the inorganic material thereof are different, the compositions change with diffusion of the inorganic material during baking and the characteristics of the obtained capacitor are influenced in some cases. The plurality of mother ceramic green sheets 12 and the mother ceramic inner-side portion outer layer may have different compositions of the inorganic material. The compositions of an organic material of the plurality of mother ceramic green sheets 12 and the mother ceramic inner-side portion outer layer may be the same or different.

The mother ceramic inner-side portion outer layer may not be provided. Further, the mother ceramic inner-side portion outer layer and the mother first ceramic outer layer 11 may be formed at the same time after the mother ceramic green sheets 12 are laminated.

Next, rigid-pressing is performed on the obtained multilayer body from the lamination direction while holding it between rigid plates 15 and 16 as illustrated in FIG. 6A. The rigid-pressing is performed by putting the multilayer body into between frames 17 and 18 surrounding the multilayer body. The rigid-pressing causes the inner electrodes 7 or the raw ceramic layers to be extruded toward the mother lead-out regions from the opposing regions through the first process and the inner electrodes 7 further deflect in the mother lead-out regions. It should be noted that the fifth process may be omitted.

Next, as illustrated in FIG. 6B, a mother ceramic outer-side portion outer layer 19 is formed so as to form a second mother ceramic outer layer. The mother ceramic outer-side portion outer layer 19, the plurality of mother ceramic green sheets 12, and the mother ceramic inner-side portion outer layer are also preferably formed by the same composition of the inorganic material for the following reason. That is, when the compositions of the inorganic material are different, the compositions will change with diffusion of the inorganic material during baking and the characteristics of the obtained capacitor are influenced in some cases. The composition of the inorganic material may be different.

The plurality of mother ceramic green sheets 12, the mother ceramic inner-side portion outer layer, and the mother ceramic outer-side portion outer layer 19 are preferably formed by different compositions of an organic material. The mother ceramic outer-side portion outer layer 19 preferably has low viscosity of the organic material or has a large content of the organic material in comparison with those of the mother ceramic green sheets 12 and the mother ceramic inner-side portion outer layer for the following reason. With this, the fluidity of the organic material of the mother ceramic outer-side portion outer layer 19 is further enhanced at the time of pressing in a seventh process, which will be described later.

Next, as illustrated in FIG. 6C, pressing is performed on the obtained multilayer body from the upper side of the mother ceramic outer-side portion outer layer 19 in the lamination direction while holding it between the rigid plates 15 and 16 so as to form the mother ceramic multilayer body. In this case, pressing is performed from the upper side of the mother ceramic outer-side portion outer layer 19. Therefore, the mother ceramic outer-side portion outer layer 19 flows into the mother lead-out regions so as to eliminate the difference in the density. With this, pressure is applied to the mother lead-out regions, so that the inner electrodes can be bent. Pressing is preferably performed while putting rubber sheets into between the obtained multilayer body and the rigid plates. It is more preferable that the rubber sheets be softer than the mother ceramic outer-side portion outer layer 19 because pressure can be further applied to the mother lead-out regions. The rubber sheets may be held on both the surfaces of the multilayer body and between the rigid plates 15 and 16 or on one surface thereof only and between the rigid plate 15 or 16. Preferably, the rubber sheet is put on the one surface only. When the rubber sheet is put on the one side only, the process of forming the mother ceramic outer-side portion outer layer 19 and the process of performing pressing can be executed while placing the multilayer body on the rigid plate 16 and so it is more efficient. The second-described process may be omitted and only the pressing in this process may be performed instead. Also in this case, the bent portions of the inner electrodes are deviated in the lead-out direction.

Next, individual multilayer bodies are obtained by cutting the mother multilayer body. In this case, a cutting blade is inserted between the two bent portions present on one inner electrode 7 for cutting. When a portion between the two bent portions is cut, stripping on the multilayer body at both the sides is significantly reduced or prevented more effectively. Further, the cutting is preferably performed in a pushed manner. The cutting is performed in the lamination direction in which the adhesion force is improved with bending, so that stripping is further made difficult or prevented from being generated.

After that, the individual multilayer bodies are baked. As the baking condition, the temperature is increased to about 1100° C. to about 1300° C., for example.

Finally, the outer electrodes are applied to the outer surfaces of the individual multilayer bodies by coating of paste or plating so as to obtain the multilayer ceramic capacitors as an example of the multilayer ceramic electronic component of a preferred embodiment of the present invention.

The multilayer ceramic electronic component according to a preferred embodiment of the present invention is not limited to being manufactured by the above-mentioned manufacturing method. The multilayer ceramic electronic component can be manufactured easily by performing pressing by at least two times before the process of cutting the above-mentioned mother multilayer body as in the above-mentioned method. The pressing at least two times includes a first pressing of applying higher pressure to the opposing regions rather than to the mother lead-out regions, extruding the inner electrodes 7 or the raw ceramic layers toward the mother lead-out regions from the opposing regions, and causing the inner electrodes to deflect, and a second pressing of applying higher pressure than that in the first pressing to the lead-out regions and bending the inner electrodes.

Next, a detailed experimental example will be described.

As an experimental example, a multilayer ceramic capacitor according to a preferred embodiment of the present invention was manufactured while the target thickness per ceramic layer after baking is set to about 0.6 μm, the target thickness of the inner electrodes after baking is set to about 0.45 μm, and the number of inner electrodes is set to 260. The length of the obtained multilayer ceramic capacitor from the end surfaces to the opposing region in the lead-out direction, that is, the length of the lead-out regions is about 45 μm. Further, the length between the opposing regions in the lead-out direction of the mother lead-out region, that is, the length of the mother lead-out regions is about 90 μm.

The outer dimension is about 0.6 mm×about 0.3 mm×about 0.3 mm. When the difference in the density is indicated by a step as the difference in the total thickness of the inner electrodes between the lead-out regions and the opposing regions, about 0.45 μm×about 130=about 58.5 μm is satisfied. Further, a step ratio obtained by dividing the step by the thickness of an inner layer block as a layer provided between the inner electrode which is closest to the first main surface and the inner electrode which is closest to the second main surface on the lead-out region is 58.5/{(0.6+0.45)×260}=0.21.

The step ratio may be obtained by dividing a difference between an interval between the inner electrodes located at both ends in the lamination direction, which pass through the center of the opposing region, and an interval between the inner electrodes located at both ends in the lamination direction, which pass through the center of the lead-out region by the thickness of the multilayer body.

The twenty cross sections of the multilayer ceramic capacitor manufactured in the experiment example along the direction perpendicular or substantially perpendicular to the inner electrodes, which is the direction connecting the inner electrodes to the first and second end surfaces, were observed. As a result, the delamination was not observed in any cases.

Various preferred embodiments of the present invention are effective for a multilayer ceramic capacitor having a large step or a large step ratio. Therefore, various preferred embodiments of the present invention are preferably used for a multilayer ceramic capacitor having the step of equal to or larger than about 58.5 μm and the step ratio of equal to or larger than about 0.21.

As described above, in the experimental example, the length of the lead-out regions of the obtained multilayer ceramic capacitor in the lead-out direction preferably is set to about 45 μm, for example. Alternatively, various preferred embodiments of the present invention may also be preferably applied to the multilayer ceramic capacitor of which lead-out regions have the length of shorter than about 45 μm, for example.

Normally, when the length of the lead-out regions is shorter, it is difficult to put the rubber sheet into the lead-out regions even if pressing is performed with the rubber sheet. Due to this, sufficient pressure cannot be applied to the lead-out regions. In contrast, in the above-mentioned manufacturing method, rigid-pressing or the like is performed before the pressing with the rubber sheet, so that the inner electrodes or the ceramic layers can be extruded to the lead-out regions from the opposing region, thus increasing the density of the inner electrodes on the lead-out regions.

Thereafter, when the pressing is performed with the rubber sheet, even if the rubber sheet cannot be put into the lead-out regions, the adhesion force between the inner electrodes and the ceramic layers is enhanced. In addition, bending on the inner electrodes is also easy to be generated so as to enhance the adhesion force between the inner electrodes and the ceramic layers by the bending.

For the above-mentioned reasons, various preferred embodiments of the present invention can be also applied to the multilayer ceramic capacitor of which length of the lead-out regions is shorter than about 45 μm, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a ceramic body including a plurality of ceramic layers laminated on each other in a lamination direction, and first and second main surfaces and first and second end surfaces;
first and second outer electrodes that are provided on the first and second end surfaces of the ceramic body, respectively; and
a plurality of first and second inner electrodes that are led out onto the first and second end surfaces of the ceramic body, respectively, and oppose each other across the ceramic layers in the lamination direction; wherein
a region in which the plurality of first inner electrodes and the plurality of second inner electrodes oppose each other corresponds to an opposing region, and portions which are located between the opposing region and the first end surface and between the opposing region and the second end surface and in which the plurality of first inner electrodes and the plurality of second inner electrodes do not oppose each other correspond to lead-out regions;
at least two inner electrodes which are located next to each other via the ceramic layer among the plurality of first and second inner electrodes include bent portions on the lead-out regions; and
a vertex of a bent portion of the inner electrode and a vertex of a bent portion of the inner electrode adjacent to the inner electrode in the lamination direction are provided at different positions along a lead-out direction in one lead-out region.

2. The multilayer ceramic electronic component according to claim 1, wherein at least one bent portion is provided on each of at least three inner electrodes aligned to be adjacent in the lamination direction among the plurality of first and second inner electrodes.

3. The multilayer ceramic electronic component according to claim 2, wherein a position of a vertex of a bent portion which is closest to the opposing region in the lead-out direction of the first and second inner electrodes in the at least one bent portion is deviated to a side of the opposing region in the lead-out direction toward a side of the second main surface of the ceramic body from a side of the first main surface of the ceramic body in the lamination direction.

4. The multilayer ceramic electronic component according to claim 1, wherein the bent portions are bent at an angle that is equal to or higher than about 5°.

5. The multilayer ceramic electronic component according to claim 1, wherein the bent portions are bent at an angle that is equal to or higher than about 10°.

6. The multilayer ceramic electronic component according to claim 2, wherein the at least one bent portion provided on each of at least three inner electrodes is bent at an angle that is equal to or higher than about 5°.

7. The multilayer ceramic electronic component according to claim 2, wherein the at least one bent portion provided on each of at least three inner electrodes is bent at an angle that is equal to or higher than about 10°.

8. The multilayer ceramic electronic component according to claim 3, wherein the at least one bent portion provided on each of at least three inner electrodes is bent at an angle that is equal to or higher than about 5°.

9. The multilayer ceramic electronic component according to claim 3, wherein the at least one bent portion provided on each of at least three inner electrodes is bent at an angle that is equal to or higher than about 10°.

10. A mother ceramic multilayer body in a raw state that includes a plurality of ceramic green sheets laminated on each other in a lamination direction, is an aggregate of a plurality of multilayer ceramic electronic component constituent units including first and second end surfaces, and includes first and second main surfaces; wherein
the multilayer ceramic electronic component constituent units include the plurality of ceramic green sheets, and a plurality of first and second inner electrodes that are led out onto the first and second end surfaces of the multilayer ceramic electronic component constituent units, respectively, and oppose each other across the ceramic green sheets in a lamination direction of the plurality of ceramic green sheets;
regions in which the plurality of first inner electrodes and the plurality of second inner electrodes oppose each other correspond to opposing regions, and portions which are located between the opposing regions and the first end surfaces and between the opposing regions and the second end surfaces and on which the plurality of first inner electrodes and the plurality of second inner electrodes do not oppose each other correspond to lead-out regions;
in a mother lead-out region configured by coupling the lead-out regions of first and second multilayer ceramic electronic component constituent units as the multilayer ceramic electronic component constituent units adjacent to each other, at least first and second adjacent inner electrodes among the plurality of first and second inner electrodes include bent portions; and
bent portions of which a vertex of the bent portion of the first inner electrode and a vertex of the bent portion of the second inner electrode adjacent to the first inner electrode in the lamination direction are provided at different positions in the lead-out direction are included on one lead-out region.

11. The mother ceramic multilayer body according to claim 10, wherein the plurality of first and second inner electrodes include an inner electrode on which at least three bent portions are provided per inner electrode on one mother lead-out region.

12. The mother ceramic multilayer body according to claim 11, wherein among the at least three bent portions, a distance between a vertex of a bent portion which is closest to the opposing region of the first multilayer ceramic electronic component constituent unit in the lead-out direction of the first and second inner electrodes and a vertex of a bent portion which is closest to the opposing region of the second multilayer ceramic electronic component constituent unit in the lead-out direction becomes larger toward a side of the second main surface of the mother ceramic multilayer body from a side of the first main surface of the mother ceramic multilayer body in the lamination direction.

13. The mother ceramic multilayer body according to claim 10, wherein one mother lead-out region includes an inner electrode including three bent portions per inner electrode.

14. The mother ceramic multilayer body according to claim 10, wherein one mother lead-out region includes an inner electrode including four bent portions per inner electrode.

15. The mother ceramic multilayer body according to claim 14, wherein among the four bent portions, a distance between vertexes of two bent portions other than the bent portion which is closest to the opposing region of the first multilayer ceramic electronic component constituent unit and the bent portion which is closest to the opposing region of the second multilayer ceramic electronic component constituent unit becomes larger toward a side of the second main surface of the mother ceramic multilayer body from a side of the first main surface of the mother ceramic multilayer body in the lamination direction.

16. The mother ceramic multilayer body according to claim 10, wherein the bent portions are bent at an angle that is equal to or higher than about 5°.

17. The mother ceramic multilayer body according to claim 10, wherein the bent portions are bent at an angle that is equal to or higher than about 10°.

18. The mother ceramic multilayer body according to claim 11, wherein the at least one bent portion provided on each of at least three inner electrodes is bent at an angle that is equal to or higher than about 5°.

19. The mother ceramic multilayer body according to claim 11, wherein the at least one bent portion provided on each of at least three inner electrodes is bent at an angle that is equal to or higher than about 10°.
